(19) United States
(12) Patent Application Publication
(10) Pub. No.: US 2024/0194426 A1
(43) Pub. Date: Jun. 13, 2024

(54) HIGH VOLTAGE DIRECT CURRENT RELAY WITH LOW POWER CONSUMPTION

(71) Applicant: Luxshare Intelligent Manufacture Technology (Changshu) Co., Ltd, Changshu City (CN)

(72) Inventors: Tao PENG, Changshu City (CN); Huan WANG, Changshu City (CN); Xiao SUN, Changshu City (CN); Hao HAN, Changshu City (CN)

(73) Assignee: Luxshare Intelligent Manufacture Technology (Changshu) Co., Ltd, Changshu City (CN)

(21) Appl. No.: 18/224,335

(22) Filed: Jul. 20, 2023

(30) Foreign Application Priority Data
Dec. 13, 2022 (CN) 202211593212.6

(51) Int. Cl. H01H 33/42; H01H 33/18; H01H 33/53

(52) U.S. Cl. CPC H01H 33/42; H01H 33/18; H01H 33/53

(57) ABSTRACT

A high-voltage direct current relay includes an insulating housing, a contact mechanism and a driving mechanism. The insulating housing defines a contact chamber. The contact mechanism includes a pair of immovable contacts and a movable contact. One end of the immovable contact protrudes into the contact chamber, and another end of the immovable contact protrudes beyond the insulating housing. The movable contact is located in the contact chamber. A gap is formed between the immovable contact and the movable contact. The driving mechanism includes a driving source and a pushing assembly. The power consumption of the high voltage direct current relay can be reduced.

### CROSS-REFERENCE TO RELATED APPLICATION

This patent application claims priority of a Chinese Patent Application No. 202211593212.6, filed on Dec. 13, 2022 and titled “HIGH VOLTAGE DIRECT CURRENT RELAY”, the entire content of which is incorporated herein by reference.

### TECHNICAL FIELD

The present disclosure relates to a field of relays, in particular to a high voltage direct current relay.

### BACKGROUND

A high-voltage direct current (HVDC) relay is a high-voltage direct current control device, which is used in electric vehicles and power energy storage systems. The field of electric vehicles is used in commercial vehicles, passenger vehicles, and charging piles etc. A traditional high-voltage direct current relay mainly controls the conduction of a main contact in the relay by energizing a coil to generate a magnetic field. When the high-voltage direct current relay of the coil drive type is working, the coil needs to be powered all the time from the outside. When the coil is working, it will always consume current and generate heat, which is not beneficial to energy saving of the power system. At the same time, the greater the current, the more turns the coil has. As a result, the coil takes up more volume of the direct current relay, and the weight of the entire direct current relay is heavier, which is not beneficial to the miniaturization and lightweight design of the high-voltage direct current relay.

Therefore, it is desirable to provide a new high voltage direct current relay to solve the above problems.

### SUMMARY

An object of the present disclosure is to provide a high-voltage direct current relay which can reduce the power consumption of a driving mechanism of the relay.

In order to achieve the above object, the present disclosure adopts the following technical solution: a high voltage direct current relay, including: an insulating housing defining a contact chamber: a contact mechanism including a movable contact and a pair of immovable contacts: the immovable contact being arranged on the insulating housing: one end of the immovable contact protruding into the contact chamber, and another end of the immovable contact protruding beyond the insulating housing; the movable contact being located in the contact chamber: a gap being formed between the immovable contact and the movable contact: and a driving mechanism including a driving source and a pushing assembly, the driving source being arranged outside the insulating housing, the pushing assembly being arranged in the contact chamber: the pushing assembly being configured to fix and push the movable contact to move in the contact chamber: when the driving source is supplied with a positive voltage, the driving source drives the pushing assembly to move towards the immovable contacts, so that the movable contact is in contact with the immovable contacts: and when the driving source is supplied with a reverse voltage, the driving source drives the pushing assembly to move away from the immovable contacts, thereby making the movable contact not in contact with the immovable contacts.

In order to achieve the above object, the present disclosure adopts the following technical solution: a high voltage direct current relay, including: an insulating housing defining a contact chamber: a contact mechanism including a movable contact and a pair of immovable contacts: one end of the immovable contact protruding into the contact chamber, and another end of the immovable contact protruding beyond the insulating housing: the movable contact being located in the contact chamber: and a driving mechanism including a driving source and a pushing assembly, the pushing assembly being arranged in the contact chamber: the pushing assembly being configured to fix and push the movable contact to move in the contact chamber; when the driving source is supplied with a first voltage, the driving source drives the pushing assembly to move towards the immovable contacts, so that the movable contact is in contact with the immovable contacts: and when the driving source is supplied with a second voltage opposite to the first voltage, the driving source drives the pushing assembly to move away from the immovable contacts, thereby making the movable contact not in contact with the immovable contacts.

Compared with the prior art, the present disclosure discloses the high-voltage direct current relay including the insulating housing, the contact mechanism and the driving mechanism. When the driving source is supplied with the positive voltage, the driving source drives the pushing assembly to drive the movable contact to move toward the immovable contacts, so that the movable contact is in contact with the immovable contacts. When the driving source is supplied with the reverse voltage, the driving source drives the pushing assembly to drive the movable contact to move away from the immovable contacts, thereby making the movable contact not in contact the immovable contacts. As a result, the power consumption of the high-voltage direct current relay is reduced, thereby saving the energy.

### BRIEF DESCRIPTION OF DRAWINGS

FIG. 1 is a schematic perspective view of a high-voltage direct current relay in accordance with an embodiment of the present disclosure;

FIG. 2 is a schematic perspective view of FIG. 1 from another angle;

FIG. 3 is a schematic cross-sectional view of FIG. 1;

FIG. 4 is a partially exploded perspective view of FIG. 1;

FIG. 5 is a partially exploded perspective view of an insulating housing, a contact mechanism, a driving mechanism, an arc extinguishing mechanism, a fixing seat and a connecting ring in FIG. 4;

FIG. 6 is a partially exploded perspective view of the insulating housing, the driving mechanism, the fixing seat and the connecting ring in FIG. 4;

FIG. 7 is a perspective schematic view of the driving mechanism and a movable contact in FIG. 4;

FIG. 8 is a schematic perspective view of FIG. 7 from another angle:

FIG. 9 is a perspective exploded schematic view of the driving mechanism in FIG. 8:

FIG. 10 is a perspective exploded schematic view of a pushing assembly in FIG. 8;

FIG. 11 is a perspective exploded schematic view of a fixing bracket and a support member in FIG. 10;

FIG. 12 is a schematic perspective view of the high-voltage direct current relay in accordance with another embodiment of the present disclosure; and

FIG. 13 is an exploded perspective view of FIG. 12.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”. “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one: “multiple” or “a plurality of” means two or more than two. Unless otherwise noted. “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

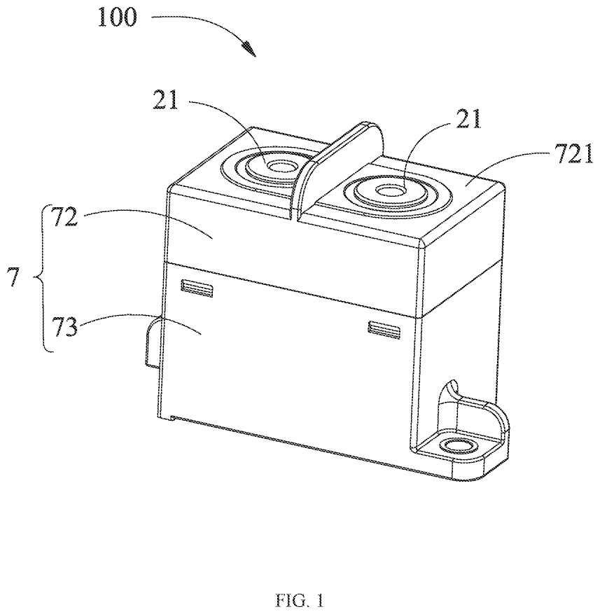

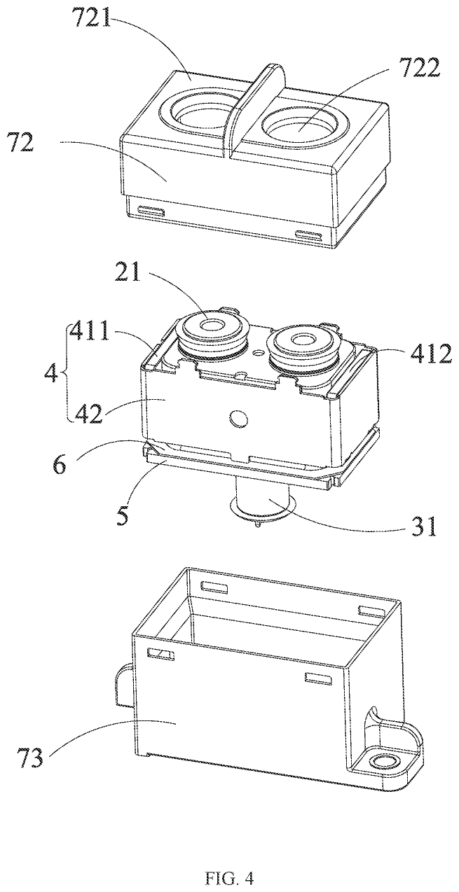

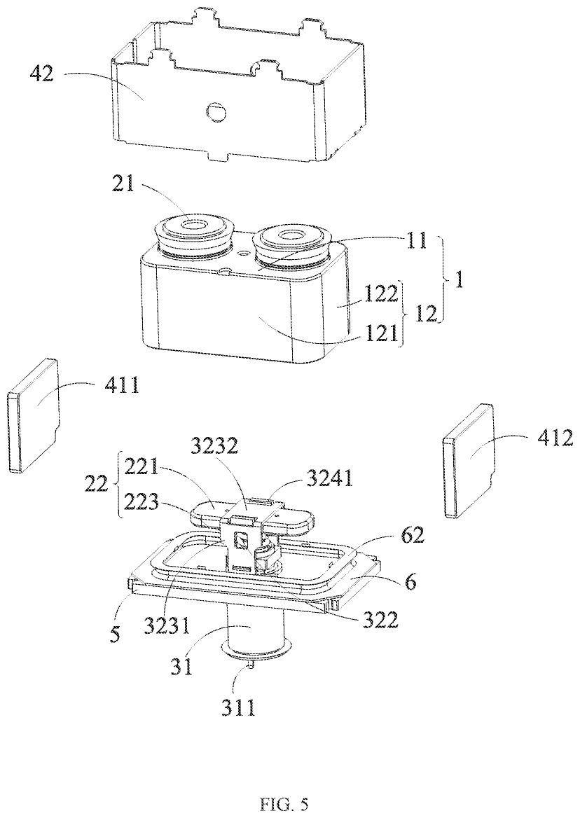

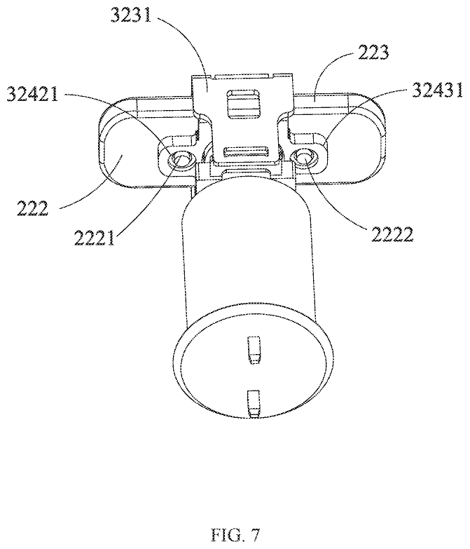

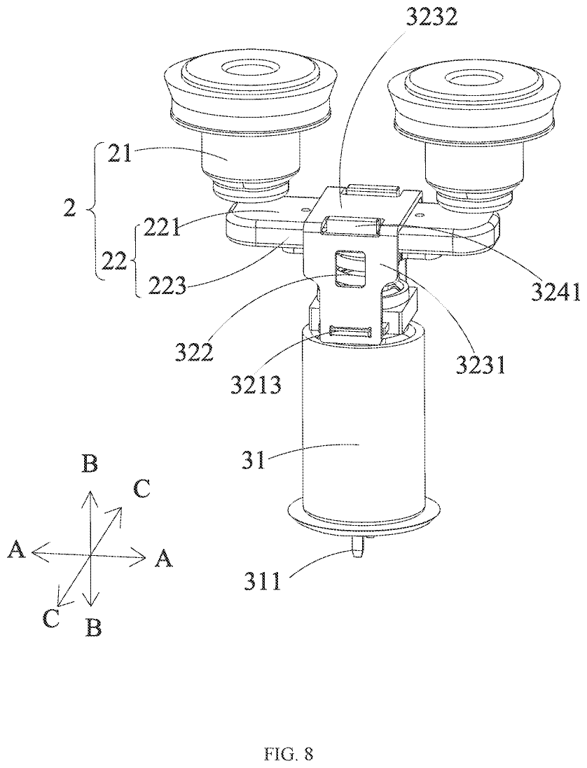

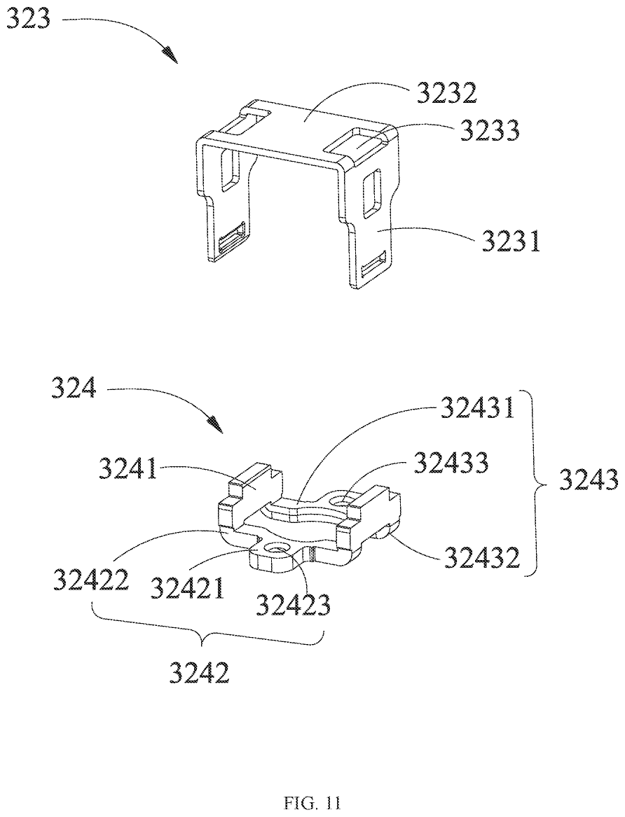

Referring to FIG. 1 to FIG. 13, the present disclosure discloses a high voltage direct current relay 100 which includes an insulating housing 1, a contact mechanism 2 and a driving mechanism 3.

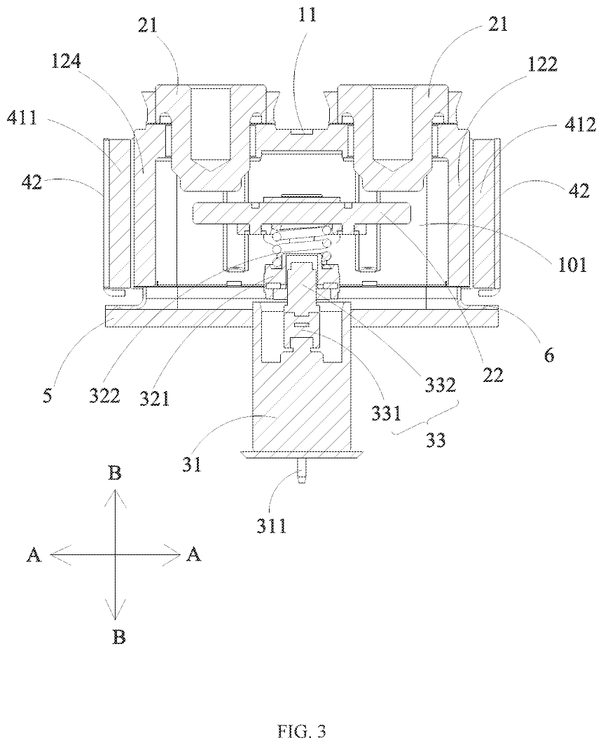

Referring to FIG. 3 to FIG. 6, the insulating housing 1 defines a contact chamber 101. The insulating housing 1 includes a top wall 11 and a plurality of side walls 12 vertically extending from edges of the top wall 11. The plurality of side walls 12 include a first side wall 121, a second side wall 122, a third side wall 123 and a fourth side wall 124. The first side wall 121, the second side wall 122, the third side wall 123 and the fourth side wall 124 are connected end to end in sequence. Preferably, the first side wall 121, the second side wall 122, the third side wall 123 and the fourth side wall 124 are sequentially connected end to end to form a cuboid. The first side wall 121, the second side wall 122, the third side wall 123, the fourth side wall 124 and the top wall 11 are surrounded to form the contact chamber 101. In the embodiment of the present disclosure, the insulating housing 1 is made of ceramic. The ceramic itself has the characteristics of high temperature resistance, corrosion resistance, no deformation and strong electrical insulation, so that the high voltage direct current relay 100 can be applied to various types of working conditions and environments.

Referring to FIG. 3 to FIG. 8, the contact mechanism 2 includes a movable contact 22 and a pair of immovable contacts 21. The pair of immovable contacts 21 are disposed on the insulating housing 1. The movable contact 22 is disposed in the contact chamber 101. A gap is formed between each immovable contact 21 and the movable contact 22. The pair of immovable contacts 21 and the movable contact 22 are spaced up and down along a height direction B-B of the insulating housing 1. The same ends of the pair of immovable contacts 21 protrude into the contact chamber 101. Specifically, the pair of immovable contacts 21 are disposed on the top wall 11. The pair of immovable contacts 21 are arranged at intervals along a length direction A-A of the insulating housing 1. The length direction A-A is perpendicular to the height direction B-B. Another ends of the pair of immovable contacts 21 protrude beyond the top wall 11. The top wall 11 has two through holes. The positions of the two through holes and the positions of the pair of immovable contacts 21 are arranged correspondingly along the height direction B-B of the insulating housing 1. The another ends of the pair of immovable contacts 21 protrude beyond the insulating housing 1 through the two through holes.

In the embodiment of the present disclosure, the movable contact 22 is in a shape of a strip. The movable contact 22 is extended along the length direction A-A. The movable contact 22 has a top portion 221, a bottom portion 222 opposite to the top portion 221, and a side portion 223 connected between the top portion 221 and the bottom portion 222. The top portion 221 is disposed toward a side of the pair of immovable contacts 21. The bottom portion 222 is disposed toward a side of the driving mechanism 3. The gap is formed between the top portion 221 and each immovable contact 21. The top portion 221 is in contact with the immovable contact 21 or not.

Referring to FIG. 3 to FIG. 8, the driving mechanism 3 includes a driving source 31 and a pushing assembly 32. The driving source 31 is disposed outside the insulating housing 1. The pushing assembly 32 is disposed in the contact chamber 101. The pushing assembly 32 is used to fix and push the movable contact 22 to reciprocate in the contact chamber 101 along the height direction B-B.

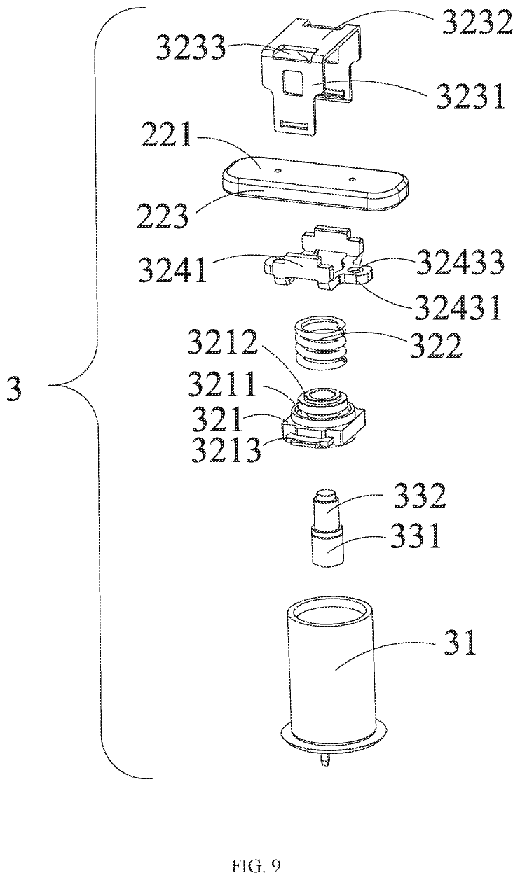

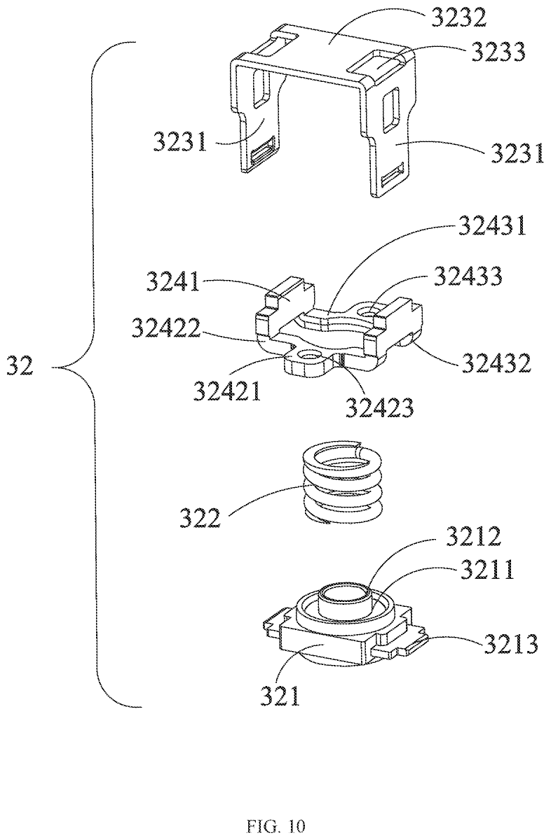

Referring to FIG. 9 and FIG. 10, the pushing assembly 32 includes an insulating member 321 and an elastic member 322. The insulating member 321 is connected to a driving end of the driving source 31. One end of the insulating member 321 along the height direction B-B is connected to the driving end of the driving source 31. Another end of the insulating member 321 along the height direction B-B is connected to one end of the elastic member 322. Another end of the elastic member 322 is connected to the bottom portion 222 of the movable contact member 22 along the height direction B-B. A groove portion 3211 is formed on a side of the insulating member 321 facing the elastic member 322. A fixing post 3212 is also disposed in the groove portion 3211. One end of the elastic member 322 passes through the fixing post 3212 and is fixed in the groove portion 3211, so that the elastic member 322 is not easily detached from the insulating member 321. In the embodiment of the present disclosure, the elastic member 322 is a spring.

Referring to FIG. 9 and FIG. 10, the pushing assembly 32 further includes a fixing bracket 323 for fixing the movable contact 22. The fixing bracket 323 includes two first fixing portions 3231 and a second fixing portion 3232. One ends of the two first fixing portions 3231 are disposed on opposite sides of the second fixing portion 3232, respectively. Another ends of the first fixing portion 3231 away from the second fixing portion 3232 are fixedly connected to the insulating member 321. The second fixing portion 3232 is in contact with the top portion 221 of the movable contact 22. Specifically, the two first fixing portions 3231 are disposed on opposite sides of the second fixing portion 3232, respectively, along a width direction C-C. The width direction C-C, the height direction B-B and the length direction A-A are perpendicular to each other. The two first fixing portions 3231 are connected with the second fixing portion 3232 to form a U-shaped frame. The movable contact 22 is disposed in the U-shaped frame. A reinforcing plate 3213 is further provided in the insulating member 321. The reinforcing plate 3213 is disposed adjacent to the driving source 31. The reinforcing plate 3213 protrudes beyond the insulating member 321 along the width direction C-C. One ends of the two first fixing portions 3231 away from the second fixing portion 3232 are connected to the reinforcing plate 3213, respectively, which enables the fixing between the fixing bracket 323 and the insulating member 321. It prevents poor contact between the movable contact 22 and the two immovable contacts 21 due to the movement of the movable contact 22 in the fixing bracket 323, thereby preventing the normal operation of the high voltage direct current relay 100 from being affected.

Referring to FIG. 9 to FIG. 11, the pushing assembly 32 further includes a support member 324. The support member 324 is fixed on the bottom portion 222 of the movable contact 22 and extends to the side portion 223 of the movable contact 22. A support top portion of the support member 324 is provided with a buckle portion 3241. The fixing bracket 323 is provided with a buckle groove 3233 matched with the buckle portion 3241. A buckle groove 3233 is disposed between the first fixing portion 3231 and the second fixing portion 3232. The buckle portion 3241 passes through the buckle groove 3233 along the height direction B-B on the side portion 223 of the movable contact 22, and is fixed, which enables the support member 324 to cooperate with the fixing bracket 323 to further enhance the fixing stability of the movable contact 22 in the fixing bracket 323.

The support member 324 includes a first support arm 3242 and a second support arm 3243. A receiving space is formed between the first support arm 3242, the second support arm 3243 and the bottom portion 222 of the movable contact 22. The elastic member 322 is clamped in the receiving space. The structure of the first support arm 3242 is the same as that of the second support arm 3243. Specifically, the first support arm 3242 includes a first support portion 32421 and first bent portions 32422 disposed at two ends of the first support portion 32421. The two first bent portions 32422 extend toward a side of the movable contact 22 along the height direction B-B. The two first bent portions 32422 are respectively perpendicular to the first support portion 32421. The first support portion 32421 has a first fixing hole 32423. The bottom portion 222 of the movable contact 22 has a first positioning post 2221. The first positioning post 2221 and the first fixing hole 32423 are disposed correspondingly up and down along the height direction B-B. The first fixing bole 32423 is sleeved on the first positioning post 2221, so that the first support portion 32421 is fixed with the bottom portion 222 of the movable contact 22. The second support arm 3243 includes a second support portion 32431 and second bent portions 32432 disposed at two ends of the second support portion 32431. The two second bent portions 32432 extend toward one side of the movable contact 22 along the height direction B-B. The two second bent portions 32432 are respectively perpendicular to the second support portion 32431. The second support portion 32431 has a second fixing hole 32433. The bottom portion 222 of the movable contact 22 has a second positioning post 2222. The first positioning post 2221 and the second positioning post 2222 are arranged symmetrically along a center of the movable contact 22. The first positioning post 2221 and the second positioning post 2222 are arranged at intervals along the length direction A-A. The second positioning post 2222 and the second fixing hole 32433 are disposed correspondingly up and down along the height direction B-B. The second fixing hole 32433 is sleeved on the second positioning post 2222, so that the second support portion 32431 is fixed with the bottom portion 222 of the movable contact 22. The first bent portion 32422 and the second bent portion 32432 on the same side are provided with the buckle portion 3241. The receiving space is formed by the first support portion 32421, the second support portion 32431 and the bottom portion 222 of the movable contact 22. The elastic member 322 is clamped in the receiving space to prevent the movable contact 22 from moving in the fixing bracket 323. As a result, poor contact between the movable contact 22 and the two immovable contacts 21 is prevented, thereby preventing the normal operation of the high voltage direct current relay 100 from being affected.

Referring to FIG. 3 to FIG. 6, the driving mechanism 3 further includes a transmission assembly 33. The transmission assembly 33 is disposed between the driving source 31 and the insulating member 321. The transmission assembly 33 includes a linkage shaft 331 and a transmission shaft 332. One end of the linkage shaft 331 is connected to the driving source 31. The other end of the linkage shaft 331 is connected to one end of the transmission shaft 332. The other end of the transmission shaft 332 is threadedly connected to the insulating member 321. The driving end of the driving source 31 and the linkage shaft 331 are locked by threads, so that the connection between the driving source 31 and the linkage shaft 331 is reliable, and not affected by mechanical shocks such as vibration. Instantaneous arcing between the movable contact 22 and the immovable contacts 21 is avoided, thereby improving the reliability of the high voltage direct current relay 100 in use.

Referring to FIG. 3 to FIG. 5, the high voltage direct current relay 100 further includes an arc extinguishing mechanism 4. The arc extinguishing mechanism 4 is arranged around a periphery of the insulating housing 1. The arc extinguishing mechanism 4 includes two oppositely arranged magnets, and a magnetic conductive plate 42. The magnetic conductive plate 42 is disposed around a periphery of the side wall 12 of the insulating housing 1. An interval is formed between the magnetic conductive plate 42 and the side wall 12 of the insulating housing 1. The two magnets are disposed in the interval. The magnetic conductive plate 42 can form a stable magnetic field around a contact point between the movable contact 22 and the immovable contact 21. Specifically, the magnets include a first magnet 411 and a second magnet 412. The first magnet 411 is disposed between the first side wall 121 and the magnetic conductive plate 42. The second magnet 412 is disposed between the third side wall 123 and the magnetic conductive plate 42. Specifically, the polarities of the surfaces facing each other of the first magnet 411 and the second magnet 412 are opposite. That is to say, when a wall surface of the first magnet 411 facing the first side wall 121 is an S pole, a wall surface of the first magnet 411 facing away from the first side wall 121 is an N pole. Accordingly, a wall surface of the second magnet 412 facing the third side wall 123 is an N pole, and a wall surface of the second magnet 412 facing away from the third side wall 123 is an S pole. A magnetic field can be generated between the first magnet 411 and the second magnet 412, so that an arc can be extended. Furthermore, the arc can be eliminated, ensuring that the high voltage relay 100 can work in a safe environment.

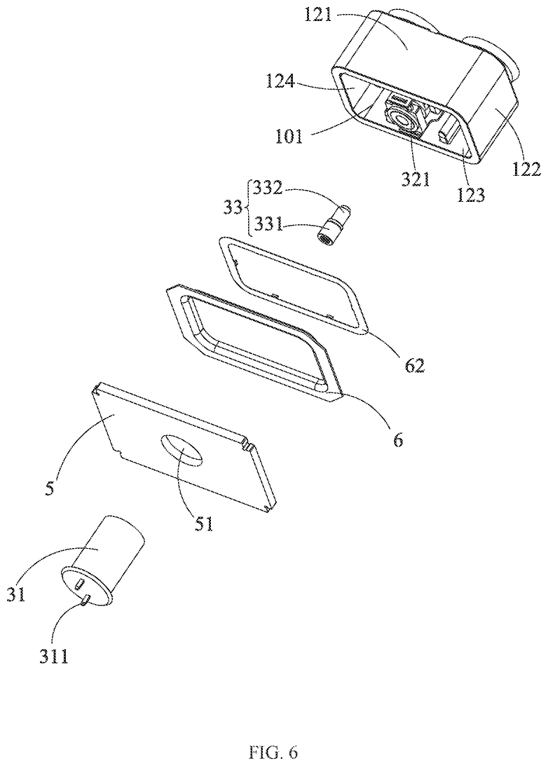

Referring to FIG. 6, the high voltage direct current relay 100 also includes a fixing seat 5. Both the insulating housing 1 and the arc extinguishing mechanism 4 are disposed above the fixing seat 5. The driving mechanism 3 is disposed below the fixing seat 5. The fixing seat 5 has a positioning hole 51. The driving end of the driving mechanism 3 passes through the positioning hole 51 so as to be connected with the movable contact 22. Preferably, a projected area of the insulating housing 1 in the height direction B-B is smaller than a projected area of the fixing seat 5.

Referring to FIG. 6, the high voltage direct current relay 100 further includes a connecting ring 6. The connecting ring 6 is disposed between the fixing seat 5 and the insulating housing 1. The connecting ring 6 is arranged around an edge of the fixing seat 5. The connecting ring 6 is annular, and the connecting ring 6 has an annular portion 61. The annular portion 61 is disposed toward the side wall 12 of the insulating housing 1 along the height direction B-B. The annular portion 61 is connected to the side wall 12 of the insulating housing 1. The size of the annular portion 61 is consistent with the cross-sectional size of the side wall 12. A gasket 62 is further provided between the annular portion 61 and the side wall 12, so that the space between the annular portion 61 and the side wall 12 can be closed to prevent the overflow of the arc from affecting the safety of the high voltage direct current relay 100.

The high voltage direct current relay 100 also includes an outer shell 7. Preferably, the outer shell 7 is made of plastic material, which can play an insulating role. The insulating housing 1, the contact mechanism 2 and the driving mechanism 3 are arranged in the outer shell 7. The outer shell 7 includes a first outer shell 72 and a second outer shell 73. The first outer shell 72 and the second outer shell 73 are arranged up and down along the height direction B-B. The first outer shell 72 and the second outer shell 73 are closed up and down to form a receiving cavity for receiving the insulating housing 1, the contact mechanism 2 and the driving mechanism 3. The first top wall 721 of the first outer shell 72 has two first through holes 722 which are disposed corresponding to the immovable contacts 21 up and down along the height direction. The immovable contact 21 at least partially exposes the corresponding first through hole 722. A first bottom wall 731 of the second outer shell 73 has a second through hole. The second through hole is disposed corresponding to the driving source 31 up and down along the height direction B-B. A wire inlet end of the driving source 31 is at least partially exposed to the second through hole.

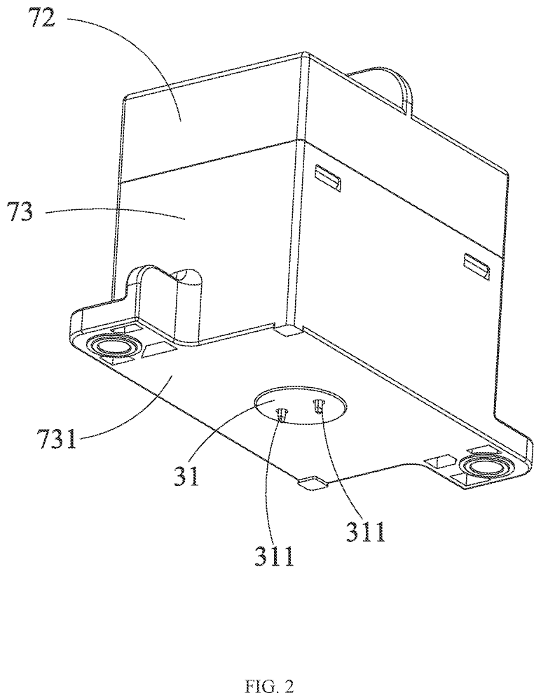

Referring to FIG. 1 and FIG. 2, in the first embodiment, the wire inlet end of the driving source 31 has a connection terminal 311. The connection terminal 311 is disposed at a bottom of the driving source 31. The high voltage direct current relay 100 can be electrically connected to a circuit board through the connection terminal 311.

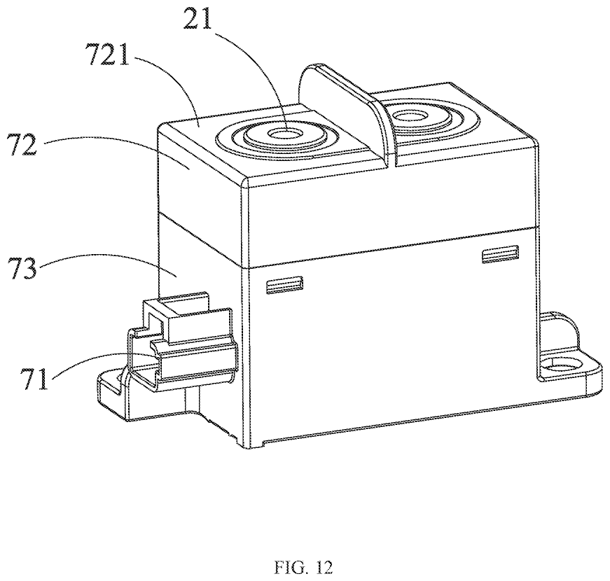

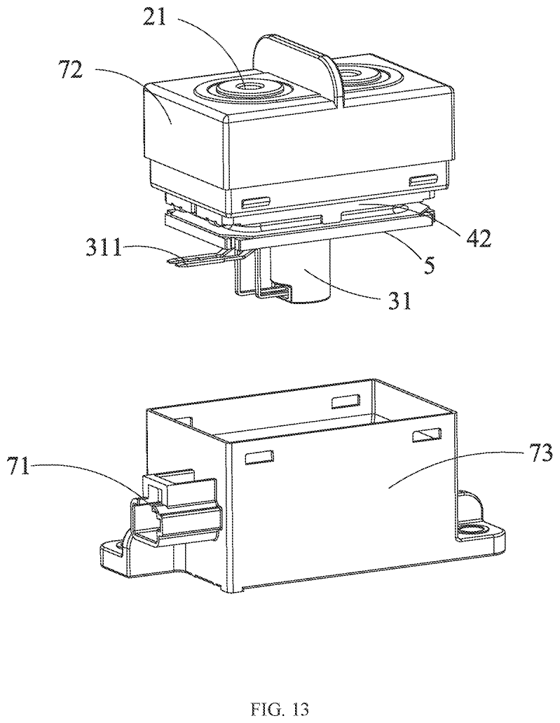

Referring to FIG. 12 and FIG. 13, in a second embodiment of the present disclosure, the outer shell 7 is provided with a receptacle connector 71. The driving source 31 is electrically connected to the receptacle connector 71. Preferably, the receptacle connector 71 is disposed on the second outer shell 73. The driving source 31 is electrically connected to the receptacle connector 71 through the connection terminal 311 or wires, which can enrich the usage scenarios of the high voltage direct current relay 100.

When the driving source 31 is supplied with a positive voltage, the driving source 31 drives the pushing assembly 32 to move towards the immovable contacts 21, and the movable contact 22 is in contact with the immovable contacts 21. Specifically, when the driving source 31 is supplied with the positive voltage, the driving end of the driving source 31 drives the insulating member 321 to move upwardly along the height direction B-B through the linkage shaft 331 and the transmission shaft 332. At this time, the insulating member 321 pushes the movable contact 22 to move upwardly through the elastic member 322. The top portion 221 of the movable contact 22 is closed with the two immovable contacts 21, and the high voltage direct current relay 100 is turned on.

When the driving source 31 is supplied with a reverse voltage, the driving source 31 drives the pushing assembly 32 to move away from the immovable contacts 21, and the movable contact 22 is not in contact with the immovable contacts 21. Specifically, when the driving source 31 is supplied with the reverse voltage, the driving end of the driving source 31 drives the insulating member 321 to move downwardly along the height direction B-B through the linkage shaft 331 and the transmission shaft 332. At this time, the insulating member 321 drives the movable contact member 22 to move downwardly through the elastic member 322. The top portion 221 of the movable contact 22 is not in contact with the two immovable contacts 21, and a circuit of the high voltage direct current relay 100 is turned off.

The moment when the driving source 31 drives the movable contact 22 to close with the two immovable contacts 21, the driving source 31 consumes power from an external low-voltage power supply. After the closing of the movable contact 22 and the two immovable contacts 21 is completed, the driving source 31 does not need to continue supplying low-voltage power to maintain the conduction of the high-voltage direct current relay 100. At this time, the driving of the high voltage direct current relay 100 can achieve zero power consumption.

Besides, in the embodiment illustrated in the present disclosure, the driving source 31 is a motor. The volume of the motor can be made very small, thereby saving the space of the high-voltage direct current relay 100, reducing the volume and weight. The size of the high voltage direct current relay 100 can be reduced at the same time, the installation is convenient, and the miniaturization and lightweight design are also convenient.

Because the driving source 31 is the motor, the driving speed of the motor is high and the speed is fast; the time for the driving source 31 to push the movable contact 22 to contact or not contact the two immovable contacts 21 is greatly shortened. The occurrence of bad parameter problems such as simultaneous pull-in and rebound is avoided, thereby greatly improving the performance of the high-voltage direct current relay 100.

In summary, the present disclosure discloses the high voltage direct current relay 100, which includes the insulating housing 1, the contact mechanism 2 and the driving mechanism 3. When the driving source 31 is supplied with the positive voltage, the driving source 31 drives the pushing assembly 32 to drive the movable contact 22 to move toward the immovable contacts 21, so that the movable contact 22 is in contact with the immovable contacts 21. When the driving source 31 is supplied with the reverse voltage, the driving source 31 drives the pushing assembly 32 to drive the movable contact 22 to move away from the immovable contacts 21, and the movable contact 22 is not in contact with the immovable contacts 21. As a result, the power consumption of the high voltage direct current relay 100 is reduced, energy is saved, and the weight of the high voltage direct current relay 100 is reduced, which is convenient for miniaturization and light weight design requirements.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A high voltage direct current relay, comprising:
an insulating housing defining a contact chamber;
a contact mechanism comprising a movable contact and a pair of immovable contacts; the immovable contact being arranged on the insulating housing; one end of the immovable contact protruding into the contact chamber, and another end of the immovable contact protruding beyond the insulating housing: the movable contact being located in the contact chamber; a gap being formed between the immovable contact and the movable contact; and
a driving mechanism comprising a driving source and a pushing assembly, the driving source being arranged outside the insulating housing, the pushing assembly being arranged in the contact chamber; the pushing assembly being configured to fix and push the movable contact to move in the contact chamber:
when the driving source is supplied with a positive voltage, the driving source drives the pushing assembly to move towards the immovable contacts, so that the movable contact is in contact with the immovable contacts; and
when the driving source is supplied with a reverse voltage, the driving source drives the pushing assembly to move away from the immovable contacts, thereby making the movable contact not in contact with the immovable contacts.

2. The high voltage direct current relay according to claim 1, wherein the pushing assembly comprises an insulating member and an elastic member: the insulating member is connected to a driving end of the driving source: one end of the elastic member is connected to the insulating member, and another end of the elastic member is connected to a bottom portion of the movable contact.

3. The high voltage direct current relay according to claim 2, wherein the pushing assembly further comprises a fixing bracket for fixing the movable contact; the fixing bracket comprises two first fixing portions and a second fixing portion: one ends of the two first fixing portions are arranged on opposite sides of the second fixing portion, respectively: ends of the first fixing portions away from the second fixing portion are fixedly connected to the insulating member; and the second fixing portion is in contact with a top portion of the movable contact.

4. The high voltage direct current relay according to claim 3, wherein the pushing assembly further comprises a support member: the support member is fixedly arranged on the bottom portion of the movable contact and extends to a side portion of the movable contact: a buckle portion is provided on a support top portion of the support member; and the fixing bracket is provided with a buckle groove matched with the buckle portion.

5. The high voltage direct current relay according to claim 4, wherein the support member comprises a first support arm and a second support arm; a receiving space is formed between the first support arm, the second support arm and the bottom portion of the movable contact; and the elastic member is clamped in the receiving space.

6. The high voltage direct current relay according to claim 2, wherein the driving mechanism further comprises a transmission assembly arranged between the driving source and the insulating member; the transmission assembly comprises a linkage shaft and a transmission shaft; one end of the linkage shaft is connected to the driving source, and another end of the linkage shaft is connected to one end of the transmission shaft; and another end of the transmission shaft is threadedly connected to the insulating member.

7. The high voltage direct current relay according to claim 1, further comprising an arc extinguishing mechanism arranged around a periphery of the insulating housing.

8. The high voltage direct current relay according to claim 7, wherein the arc extinguishing mechanism comprises two oppositely arranged magnets, and a magnetic conductive plate; the magnetic conductive plate is arranged around a periphery of a side wall of the insulating housing; an interval is formed between the magnetic conductive plate and the side wall of the insulating housing; and the magnets are disposed in the interval.

9. The high voltage direct current relay according to claim 8, further comprising a fixing seat: wherein the insulating housing, the magnets and the magnetic conductive plate are all arranged on the fixing seat; and a driving end of the driving source passes through the fixing seat so as to be connected to the insulating member.

10. The high voltage direct current relay according to claim 1, wherein a wire inlet end of the driving source has a connection terminal, and the connection terminal is configured to be electrically connected to a circuit board.

11. The high voltage direct current relay according to claim 1, further comprising an outer shell: wherein the insulating housing, the contact mechanism and the driving mechanism are arranged in the outer shell; the outer shell is provided with a receptacle connector, and the driving source is electrically connected with the receptacle connector.

12. A high voltage direct current relay, comprising:
an insulating housing defining a contact chamber:
a contact mechanism comprising a movable contact and a pair of immovable contacts: one end of the immovable contact protruding into the contact chamber, and another end of the immovable contact protruding beyond the insulating housing: the movable contact being located in the contact chamber; and
a driving mechanism comprising a driving source and a pushing assembly, the pushing assembly being arranged in the contact chamber: the pushing assembly being configured to fix and push the movable contact to move in the contact chamber;
when the driving source is supplied with a first voltage, the driving source drives the pushing assembly to move towards the immovable contacts, so that the movable contact is in contact with the immovable contacts; and
when the driving source is supplied with a second voltage opposite to the first voltage, the driving source drives the pushing assembly to move away from the immovable contacts, thereby making the movable contact not in contact with the immovable contacts.

13. The high voltage direct current relay according to claim 12, wherein the pushing assembly comprises an insulating member and an elastic member; the insulating member is connected to a driving end of the driving source: one end of the elastic member is connected to the insulating member, and another end of the elastic member is connected to a bottom portion of the movable contact.

14. The high voltage direct current relay according to claim 13, wherein the pushing assembly further comprises a fixing bracket for fixing the movable contact: the fixing bracket comprises two first fixing portions and a second fixing portion; one ends of the two first fixing portions are arranged on opposite sides of the second fixing portion, respectively: ends of the first fixing portions away from the second fixing portion are fixedly connected to the insulating member; and the second fixing portion is in contact with a top portion of the movable contact.

15. The high voltage direct current relay according to claim 14, wherein the pushing assembly further comprises a support member: the support member is fixedly arranged on the bottom portion of the movable contact and extends to a side portion of the movable contact; a buckle portion is provided on a support top portion of the support member; and the fixing bracket is provided with a buckle groove matched with the buckle portion.

16. The high voltage direct current relay according to claim 15, wherein the support member comprises a first support arm and a second support arm; a receiving space is formed between the first support arm, the second support arm and the bottom portion of the movable contact; and the elastic member is clamped in the receiving space.

17. The high voltage direct current relay according to claim 13, wherein the driving mechanism further comprises a transmission assembly arranged between the driving source and the insulating member: the transmission assembly comprises a linkage shaft and a transmission shaft: one end of the linkage shaft is connected to the driving source, and another end of the linkage shaft is connected to one end of the transmission shaft; and another end of the transmission shaft is threadedly connected to the insulating member.

18. The high voltage direct current relay according to claim 12, further comprising an arc extinguishing mechanism arranged around a periphery of the insulating housing.

19. The high voltage direct current relay according to claim 18, wherein the arc extinguishing mechanism comprises two oppositely arranged magnets, and a magnetic conductive plate; the magnetic conductive plate is arranged around a periphery of a side wall of the insulating housing; an interval is formed between the magnetic conductive plate and the side wall of the insulating housing; and the magnets are disposed in the interval.

20. The high voltage direct current relay according to claim 19, further comprising a fixing seat; wherein the insulating housing, the magnets and the magnetic conductive plate are all arranged on the fixing seat; and a driving end of the driving source passes through the fixing seat so as to be connected to the insulating member.
